(19) United States
(12) Patent Application Publication
(10) Pub. No.: US 2023/0153755 A1
(43) Pub. Date: May 18, 2023

(54) DATA MANAGEMENT IN INVENTORY MANAGEMENT SYSTEM

(71) Applicant: 3M INNOVATIVE PROPERTIES COMPANY, St. Paul, MN (US)

(72) Inventors: Kristin L. Thunhorst, Stillwater, MN (US); Michael E. O'Brien, White Bear Lake, MN (US); Priyanka Rao, St. Paul, MN (US); Miranda Lapour, St. Paul, MN (US)

(21) Appl. No.: 17/985,368

(22) Filed: Nov. 11, 2022

Related U.S. Application Data
(60) Provisional application No. 63/278,732, filed on Nov. 12, 2021.

(51) Int. Cl. G06Q 10/08; G06Q 10/00

(52) U.S. Cl. CPC G06Q 10/0875; G06Q 10/20; G07C 9/00896

(57) ABSTRACT

Aspects of the present disclosure relate to a method for managing inventory items in a first inventory management system. The method can include determining, with a computing device and an optical scanning device, whether the inventory item corresponds to a first item data set based on at least one attribute for the first item data set. The method can include adding, in response to the inventory item corresponding to the first item data set, the first item data set to a plurality of item data sets in a facility inventory profile for the first inventory management system. The method can also include determining, based on a correlation between the facility inventory profile and a plurality of facility inventory profiles, a second attribute for the inventory item different from the at least one attribute. The method can include performing at least one action based on the determination of the second attribute.

### BACKGROUND

Inventory management systems can be used to facilitate transactions within a facility. In some inventory management systems, particularly those used in an automotive collision repair facility, the set up occurs to ensure that inventory items are adequately described and quantified in the software and management system. Specific examples of identification attributes for inventory items may include: item manufacturer, item unit of measure, item name and/or description, item category, count of that specific material on-hand, stocking location, price, cost, item universal product code (UPC) code, and another unique identifying code (for example, such as a QR Code), etc. Additional fields that are unique to each facility and their supplier (e.g., distributor) are also required and may include such items as: distributor, distributor replenishment frequency, size of repair operation (in terms of revenue, number of technicians, etc.), material stocking units/quantities if it differs from manufacturer stocking units/quantities, the OEM of vehicles that they are certified to repair, etc.

### BRIEF SUMMARY

In some inventory management systems, a unique identifying number (ID number) is assigned to each inventory item that is independent from other identification attributes. The results of this approach can yield a large number of unique combinations of ID numbers at a plurality of facilities. For example, if there are 10 facilities which each have 100 materials that are included in each of their inventory management systems, then the unique combination of facility and ID numbers+material data would equal be at least 1000 individual pieces of data. Such a vast quantities of data not only overburden data storage systems by creating a large number of records, but also increase time for set up and installation of an inventory management system.

Aspects of the present disclosure can relate to a method for managing inventory item in a first inventory management system. The method can include determining, with a computing device and an optical scanning device, whether the inventory item corresponds to a first item data set based on at least one attribute for the first item data set. The method can include adding, in response to the inventory item corresponding to the first item data set, the first item data set to a plurality of item data sets in a facility inventory profile for the first inventory management system. The method can also include determining, based on a correlation between the facility inventory profile and a plurality of facility inventory profiles, a second attribute for the inventory item different from the at least one attribute, wherein the plurality of facility inventory profiles are for separate repair facilities. The method can include performing at least one action based on the determination of the second attribute.

Additional aspects of the present disclosure can relate to a system for managing an inventory item in a first inventory management system. The system can include an optical scanning device and an inventory item. The system can also include a computing device in communication with the optical scanning device. The computing device can include a processor and a memory storing instructions that, when executed by the processor, configure the computing device to determine whether the inventory item corresponds to a first item data set based on at least one attribute for the first item data set. The memory can further configure the computing device to add, in response to the inventory item corresponding to the first item data set, the first item data set to a plurality of item data sets in a facility inventory profile for the first inventory management system. The memory can further configure the computing device to determine, based on a correlation between the facility inventory profile and a plurality of facility inventory profiles, a second attribute for the inventory item different from the at least one attribute. The plurality of facility inventory profiles can be for separate repair facilities. The memory can further configure the computing device to perform at least one action based on the determination of the second attribute.

The system can also include an inventory device configured to store the inventory item and being communicatively coupled to the computing device. The inventory device can further include locking mechanism electronically controllable by the computing device so that the inventory item is secured within the inventory device. In at least one embodiment, the computing device can perform at least one action by controlling the locking mechanism in response to receiving the second attribute.

In at least one embodiment, the at least one attribute includes a key attribute.

In at least one embodiment, the at least one attribute is a plurality of attributes which further include a key attribute. The key attribute is a universal product code. The plurality of attributes includes a secondary attribute which can be a description, categorization attribute, a quantity attribute, or price attribute.

In at least one embodiment, determining whether the inventory item corresponds to a first item data set includes determining whether the key attribute corresponds to the first item data set, and in response to the first item data set not having a key attribute, prompting a user to enter a secondary attribute.

In at least one embodiment, the second attribute can be a list of alternative products for the first item data set, and the performing at least one action includes alerting a user of an alternative product from the list of alternative products. The list of alternative products can be products that are similar to the inventory item.

In at least one embodiment, the performing at least one action includes ordering the alternative product.

In at least one embodiment, determining a second attribute includes providing the at least one attribute from the facility inventory profile to a machine learning model trained on the plurality of facility inventory profiles, and receiving the second attribute for the plurality of item data sets from the machine learning model.

In at least one embodiment, the second attribute can be a min/max of quantity attributes.

In at least one embodiment, determining a second attribute occurs in response to determining that the attribute for the first item data set is null.

In at least one embodiment, the system or method can include adding the first item data set to an exception list in response to the inventory item not corresponding to the first item data set.

In at least one embodiment, determining the second attribute includes sending a request to a second inventory management system for the attribute.

In at least one embodiment, the second inventory management system is in communication to a a pricing data store.

In at least one embodiment, performing of at least one action includes populating a form, and presenting the form to a user.

In at least one embodiment, performing of at least one action includes locking or unlocking of a cabinet.

In at least one embodiment, performing of at least one action includes generating a list of inventory items to be ordered.

In at least one embodiment, the performing of at least one action includes controlling a light.

In at least one embodiment, the performing of at least one action includes making the first item data set available to be modified.

In at least one embodiment, the facility inventory profile comprises revenue data for a facility, a number of technicians, number of cars repaired in a certain time period, distribution or supplier partner, frequency of inventory evaluation and re-order, frequency of re-supply, and combinations thereof.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a routine 100 for managing an inventory item in a first inventory management system, in accordance with one embodiment.

FIG. 2 illustrates an aspect of the subject matter in accordance with one embodiment.

FIG. 3 depicts an illustrative computer system architecture that may be used in accordance with one or more illustrative aspects described herein.

### DETAILED DESCRIPTION

Aspects of the present disclosure relate to determining a second attribute based on a facility inventory profile and a received attribute for an inventory item. In at least one embodiment, the facility inventory profile can include using a universal product code as a key attribute for an inventory item.

Computer software, hardware, and networks may be utilized in a variety of different system environments, including standalone, networked, remote-access (aka, remote desktop), virtualized, and/or cloud-based environments, among others.

Although reference is made with structured data in a relationship data store, various aspects of the present disclosure can also include flat, hierarchical, dimensional, network, graph, or object-oriented database models using structured, semi-structured, or unstructured data.

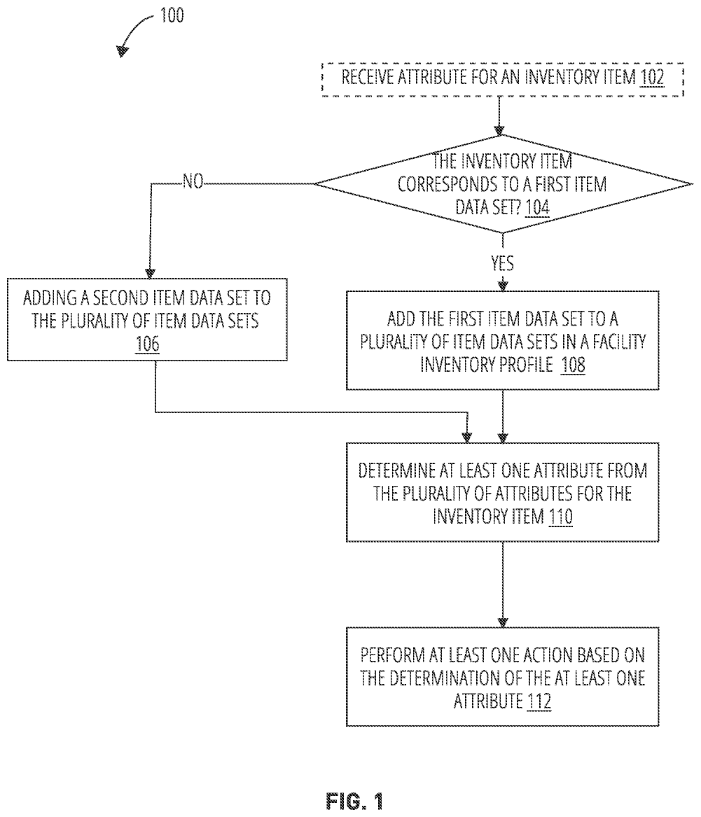

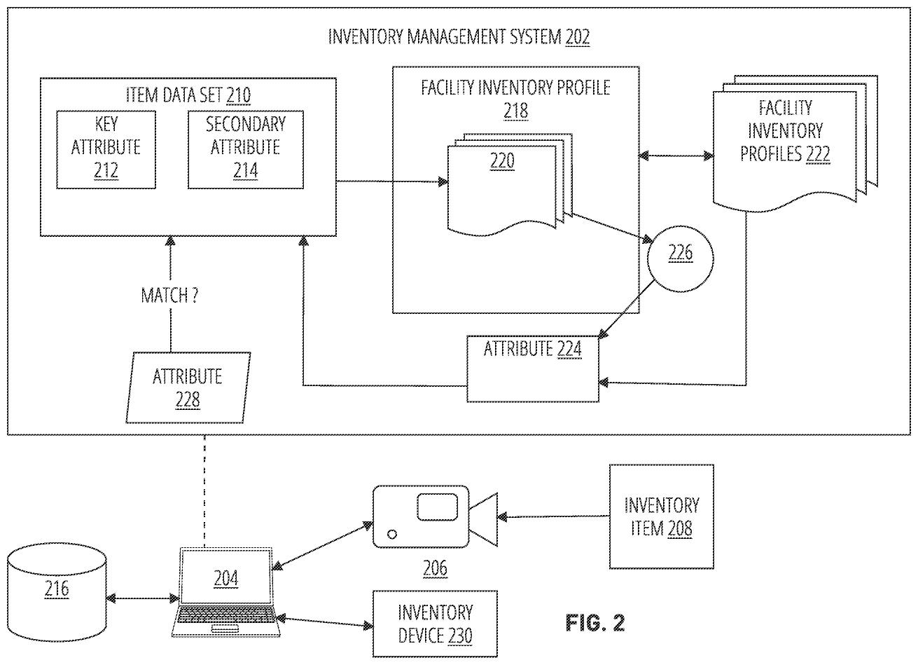

FIG. 1 illustrates a routine 100 for performing actions based on an inventory item. Aspects of routine 100 can be explained with reference to the block diagram of FIG. 2.

Routine 100 can begin with block 102. In block 102, a computing device 204 can receive an attribute 228 for the inventory item 208. The attribute 228 can be any number of item properties that are related to the inventory item such as price, UPC, quantity per unit pack, description, etc. In at least one embodiment, the attribute can be a key attribute of a universal product code. For example, a user can scan the universal product code of the inventory item using an optical scanning device 206, which is received by the computing device 204. In at least one embodiment, a universal product code may not be present, and another attribute is selected by the computer user interface. For example, if the inventory item 208 is a roll of tape without a UPC, then the user can enter an attribute (such as a description, number of yards in the roll, or a photo of the roll of tape) so that this attribute can be uploaded to the computer.

In at least one embodiment, the attribute 228 can be a secondary attribute entered from input/output interfaces by a user. In at least one embodiment, the secondary attribute can be a description, categorization attribute (how categorized), a quantity attribute, price attribute, or a derivative attribute of any of the other secondary attributes. For example, the secondary attribute 214 can be a min/max of a quantity attribute or a recommended quantity.

In decision block 104, the computing device 204 (via the inventory management system 202 routine) determines whether the inventory item 208 corresponds to an item data set 210 based on a plurality of attributes (e.g., key attribute 212, secondary attribute 214) for the item data set 210. The plurality of attributes can be stored within the inventory data store 216 as part of a database. In at least one embodiment, the computing device 204 can determine whether the inventory item 208 corresponds to the item data set 210 based on a lookup operation. For example, the attribute 228 for the inventory item can be compared to any of the plurality of attributes for a direct match. In at least one embodiment, the computing device 204 can determine whether there is a match based on associations. For example, the computing device 204 can determine that there is a correspondence between “roll” and “tape” based on n-gram analysis from other data stores.

In block 106, in response to the attribute not corresponding to the item data set 210, the computing device 204 can create an item data set using the attribute and add the item data set to the plurality of item data sets 220. For example, if a UPC or any other attribute cannot be matched to the item data set 210, then a new item data set can be created and added to the plurality of item data sets 220 in a data store.

In block 108, in response to the attribute corresponding to the item data set 210, the computing device 204 can add the item data set 210 to a plurality of item data sets 220 in the facility inventory profile 218. In at least one embodiment, the facility inventory profile 218 can be a collection of data regarding a particular repair facility. For example, the facility inventory profile 218 can include revenue data for a facility, the number of technicians, number of cars repaired in a certain time period, distribution or supplier partner, frequency of inventory evaluation and re-order, frequency of re-supply, and combinations thereof.

The item data set 210 can be added to a database having the plurality of item data sets 220. In at least one embodiment, the facility inventory profile 218 can include a plurality of inventory items that are tracked within the inventory management system 202. By adding the item data set 210, the inventory management system 202 can indicate that the inventory item is tracked and update the quantity attribute accordingly.

The facility inventory profile 218 can be unique to each repair facility. The computing device 204 can access a data store having a plurality of facility inventory profiles 222 from a plurality of repair facilities stored therein. Each facility inventory profile from the facility inventory profiles 222 can have different item data sets which can correspond to the inventory items for each repair facility.

In block 110, the computing device 204 can determine an additional attribute 228 based on the correlation between the facility inventory profile 218 with a facility inventory profile from the plurality of facility inventory profiles 222. In at least one embodiment, the recommendations for mix/max might come from a combination of facility inventory profiles 222 and inventory data store 216. For example, the mix/max may come from a historical record of inventory.

In at least one embodiment, the inventory management system 202 can access these facility inventory profiles 222 in order to compare plurality of item data sets 220 for a first repair facility with a plurality of item data sets for a second repair facility. For example, the first repair facility and the second repair facility can have similarities in terms of shop size, vehicles serviced, geographic location, and/or customer base. From this, some repair facilities may carry the same inventory items and thus, item data sets from one facility inventory profile can be used to populate item data sets from another facility inventory profile.

In at least one embodiment, the computing device 204 can determine that the attribute 224 belongs to the item data set 210 based on the aforementioned analysis. For example, if the UPC is provided in block 102, then the computing device 204 can determine that the other attribute 224 that also corresponds to the item data set 210 (e.g., the attribute 224 can be a description, unit quantity, or unit price of the inventory item 208). In at least one embodiment, the computing device 204 can further communicate by sending a request to a second inventory management system for the attribute 224.

In at least one embodiment, block 110 can be determined in response to determining that the attribute 224 for the first item data set 210 is null. For example, if the data attribute already has a value, then the computing device 204 can avoid replacing the existing value and determine the data attributes that are null.

In at least one embodiment, the inventory management system 202 can determine a similarity metric between the first repair facility (corresponding to facility inventory profile 218) and a second repair facility (corresponding to a second facility inventory profile in facility inventory profiles 222). If the similarity metric meets a threshold, e.g., meaning that the first repair facility and the second repair facility are sufficiently similar, then the inventory management system 202 can recommend additional item data sets 210 (and additional inventory items) to populate the facility inventory profile 218.

In at least one embodiment, the inventory management system 202 can further provide the plurality of item data sets 220 to a (trained) machine learning model 226 which can be trained on the plurality of facility inventory profiles 222. The machine learning model 226 can return the attribute 224 based on a relationship of the item data set 210 with other item data sets from other similar facility inventory profiles.

In block 112, the computing device 204 can perform at least one action based on the determination of the at least one attribute. For example, the computing device 204 can perform actions when an attribute 224 is returned from the facility inventory profiles 222.

In at least one embodiment, the computing device 204 can populate a form. This form can be presented to a user which can save time. For example, if a UPC is provided, and even if the UPC is not present in the item data set 210 as the key attribute 212, then the attribute within the item data set 210 can be determined from other facility inventory profiles 222 outside of the current repair facility. This can enable a lookup of an attribute based on a plurality of facility inventory profiles 222 and not just those present in inventory data store 216. This can save time and improve the data store since the data does not have to be stored locally. In at least one embodiment, the attribute 224 can include whether the inventory item 208 is usable for an original equipment manufacturer (OEM) certified repair process and controlling the inventory device 230 based on whether the inventory item 208 is certified and based on the facility inventory profile 218 (e.g., whether the repair facility is an OEM-certified repair facility).

In at least one embodiment, the attribute 224 can be a quantity attribute which can indicate a range of acceptable quantities for the inventory item. The computing device 204 can analyze the current inventory levels in response to receiving attribute 224 and further generate a list of inventory items to be ordered in response to the current inventory item 208 quantity being below the range of acceptable quantities. The inventory management system 202 can be communicatively coupled to an ordering system, or to a distribution system. In response to receiving the list to be ordered (e.g., by the computing device 204), the inventory management system 202 can order the inventory items off of the list which can further improve the performance of computing device 204 by avoiding additional inputs.

In at least one embodiment, the computing device 204 can make the first item data set 210 available to be modified in response to determining the attribute 224. For example, if attribute 224 is returned, then the computing device 204 can determine that item data set 210 is incomplete. If the item data set 210 was locked from modification (or otherwise unchangeable), then the item data set 210 would not be able to be modified. In at least one embodiment, the computing device 204 can unlock or make the item data set 210 changeable, item data set 210 in response to the presence of attribute 224. Thus, by unlocking the item data set 210, in response to a determined attribute, the computing device 204 can provide additional security for the item data set 210 and reduce unnecessary modifications to the item data set 210.

In at least one embodiment, the computing device 204 can further modify additional devices. For example, if the computing device 204 is communicatively coupled to an inventory device 230, which can be a cabinet or device for dispensing inventory item 208, the computing device 204 can control lights on the inventory device 230 or other functions such as locks, or actuators.

In one example, the computing device 204 can send instructions to a locking mechanism on the inventory device 230 to unlock a cabinet in response to the computing device determining a quantity attribute 224 from the scanned inventory item 208 and in response to the quantity attribute 224 being less than the quantity on hand. In another example, the computing device 204 can send instructions to a locking mechanism to unlock the cabinet in response to the computing device 204 determining a quantity attribute 224 from the scanned inventory item 208. If the quantity attribute 224 is zero, then the cabinet can unlock automatically as part of a check-in procedure.

In another example, the computing device 204 can send instructions to a lighting device on the inventory device 230 in response to determining a warning attribute 224, such as a recall. For example, the light can use a red color on the lane where the inventory item 208 is stored in the cabinet to communicate to a user that there is a problem with the record for the inventory item 208.

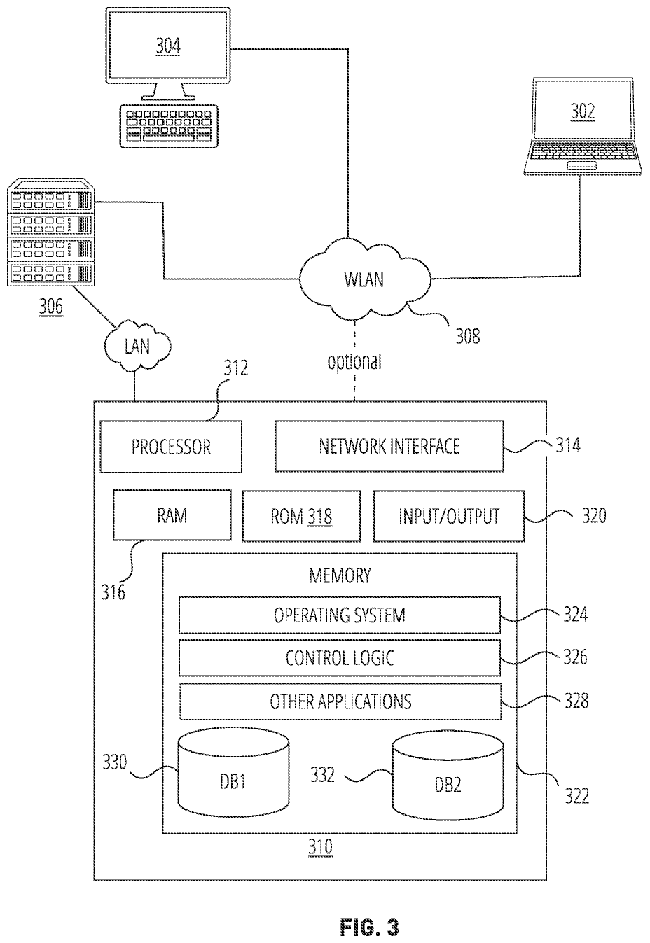

FIG. 3 illustrates one example of a system architecture and data processing device that may be used to implement one or more illustrative aspects described herein in a standalone and/or networked environment. Various network nodes, computing device 310, web server 306, computing device 304, and laptop 302 may be interconnected via a wide area network 308 (WAN), such as the internet. Other networks may also or alternatively be used, including private intranets, corporate networks, LANs, metropolitan area networks (MANs) wireless networks, personal networks (PANs), and the like. Network 308 is for illustration purposes and may be replaced with fewer or additional computer networks. A local area network (LAN) may have one or more of any known LAN topology and may use one or more of a variety of different protocols, such as ethernet. Computing device 310, web server 306, computing device 304, laptop 302 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include computing device 310, web server 306, and client computing device 304, laptop 302. computing device 310 provides overall access, control and administration of databases and control software for performing one or more illustrative aspects described herein. Computing device 310 may be connected to web server 306 through which users interact with and obtain data as requested. Alternatively, computing device 310 may act as a web server itself and be directly connected to the internet. computing device 310 may be connected to web server 306 through the network 308 (e.g., the internet), via direct or indirect connection, or via some other network. Users may interact with the computing device 310 using remote computing device 304, laptop 302, e.g., using a web browser to connect to the computing device 310 via one or more externally exposed web sites hosted by web server 306. Client computing device 304, laptop 302 may be used in concert with computing device 310 to access data stored therein, or may be used for other purposes. For example, from client computing device 304, a user may access web server 306 using an internet browser, as is known in the art, or by executing a software application that communicates with web server 306 and/or computing device 310 over a computer network (such as the internet).

Servers and applications may be combined on the same physical machines, and retain separate virtual or logical addresses, or may reside on separate physical machines. FIG. 3 illustrates just one example of a network architecture that may be used, and those of skill in the art will appreciate that the specific network architecture and data processing devices used may vary, and are secondary to the functionality that they provide, as further described herein. For example, services provided by web server 306 and computing device 310 may be combined on a single server.

Each component computing device 310, web server 306, computing device 304, laptop 302 may be any type of known computer, server, or data processing device. computing device 310, e.g., may include a processor 312 controlling overall operation of the computing device 310. computing device 310 may further include RAM 316, ROM 318, network interface 314, input/output interfaces 320 (e.g., keyboard, mouse, display, printer, etc.), and memory 322. Input/output interfaces 320 may include a variety of interface units and drives for reading, writing, displaying, and/or printing data or files. Memory 322 may further store operating system software 324 for controlling overall operation of the computing device 310, control logic 326 for instructing computing device 310 to perform aspects described herein, and other application software 328 providing secondary, support, and/or other functionality which may or may not be used in conjunction with aspects described herein. The control logic may also be referred to herein as the data server software control logic 326. Functionality of the data server software may refer to operations or decisions made automatically based on rules coded into the control logic, made manually by a user providing input into the system, and/or a combination of automatic processing based on user input (e.g., queries, data updates, etc.).

Memory 322 may also store data used in performance of one or more aspects described herein, including a first data store 332 and a second data store 330. In some embodiments, the first database may include the second database (e.g., as a separate table, report, etc.). That is, the information can be stored in a single database, or separated into different logical, virtual, or physical databases, depending on system design. Web server 306, computing device 304, laptop 302 may have similar or different architecture as described with respect to computing device 310. Those of skill in the art will appreciate that the functionality of computing device 310 (or web server 306, computing device 304, laptop 302) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

“Attribute” refers to a piece of information which determines the properties of a field or tag in a database or a string of characters in a display.

“Data store” refers to repository for persistently storing and managing collections of data. This can include databases and other file types.

“Identification characteristic” refers to a feature that enables specific identification of the vehicle (e.g., when in communication with a data store). In at least one embodiment, the identification characteristic may avoid the use of machine vision.

“Inventory item” refers to a physical item that is in a repair facility's inventory. The inventory item can refer to an item that has not been entered into an inventory management system.

“Inventory management system” refers to a software system for tracking inventory levels, orders, sales, and deliveries. The inventory management system can also be in communication with a pricing data store.

“Item data set” refers to a collection of related sets of information for a particular inventory item that is composed of separate elements but is manipulatable as a unit. The term item data set can include tuples, lists, or sets of data which may be ordered or unordered, changeable or unchangeable, and/or indexed or unindexed.

“Key attribute” refers to an attribute that forms part of a primary key. The key attribute can be used to identify the item data set.

“Machine learning model” refers to a file that is the output of a machine learning algorithm run using training data. The machine learning model has been trained to recognize certain types of patterns within the training data.

“Optical scanning device” refers to a device which uses light to scan and digitally convert images, codes, or text into computer readable formats. The optical scanning device can include camera systems, including machine vision systems that are designed to classify inventory items. The optical scanning device can also include barcode scanners.

“Repair facility” refers to an area where vehicles are repaired or stored prior to repair or after becoming repaired. For example, a repair facility can include both a building and a lot surrounding the repair facility

“Secondary attribute” refers to an attribute that is not the key attribute.

What is claimed is:

1. A method for managing an inventory item in a first inventory management system, comprising:
determining, with a computing device and an optical scanning device, whether the inventory item corresponds to a first item data set based on at least one attribute for the first item data set;
adding, in response to the inventory item corresponding to the first item data set, the first item data set to a plurality of item data sets in a facility inventory profile for the first inventory management system;
determining, based on a correlation between the facility inventory profile and a plurality of facility inventory profiles, a second attribute for the inventory item different from the at least one attribute, wherein the plurality of facility inventory profiles are for separate repair facilities;
performing at least one action based on the determination of the second attribute.

2. The method of claim 1, wherein the at least one attribute comprises a key attribute.

3. The method of claim 2, wherein the key attribute is a universal product code.

4. The method of claim 2, wherein the at least one attribute comprises a plurality of attributes further comprising:
the key attribute, and
a secondary attribute, the secondary attribute is a description, categorization attribute, a quantity attribute, or price attribute.

5. The method of claim 4, wherein determining whether the inventory item corresponds to the first item data set comprises:
determining whether the key attribute corresponds to the first item data set;
in response to the first item data set not having a key attribute, prompting a user to enter the secondary attribute.

6. The method of claim 1, wherein the first item data set comprises a list of alternative products for the first item data set, and
the method further comprising alerting a user of an alternative product from the list of alternative products.

7. The method of claim 6, wherein performing at least one action comprises ordering the alternative product.

8. The method of claim 1, wherein determining the second attribute comprises:
providing the at least one attribute from the facility inventory profile to a machine learning model trained on the plurality of facility inventory profiles, and
receiving the second attribute for the plurality of item data sets from the machine learning model.

9. The method of claim 8, wherein the second attribute is a min/max of quantity attributes.

10. The method of claim 1, wherein determining a second attribute occurs in response to determining that the attribute for the first item data set is null.

11. The method of claim 1, further comprising adding the first item data set to an exception list in response to the inventory item not corresponding to the first item data set.

12. The method of claim 1, wherein determining the second attribute comprises sending a request to a second inventory management system for the second attribute.

13. The method of claim 12, wherein the second inventory management system comprises a pricing data store.

14. The method of claim 1, wherein the performing of at least one action includes locking or unlocking of a cabinet.

15. The method of claim 1, wherein the performing of at least one action includes controlling a light.

16. The method of claim 1, wherein the performing of at least one action includes allowing the first item data set to be modified.

17. The method of claim 1, wherein the facility inventory profile comprises revenue data for a facility, a number of technicians, number of cars repaired in a certain time period, distribution or supplier partner, frequency of inventory evaluation and re-order, frequency of re-supply, and combinations thereof.

18. A system comprising:
an inventory item;
a computing device comprising:
a processor; and
a memory storing instructions that, when executed by the processor, configure the computing device to perform the method of claim 1.

19. The system of claim 18, further comprising an inventory device configured to store the inventory item and being communicatively coupled to the computing device, wherein the inventory device comprises a locking mechanism electronically controllable by the computing device.

20. The system of claim 19, wherein performing at least one action comprises controlling the locking mechanism in response to receiving the at least one attribute.
